(19) United States
(12) Patent Application Publication
(10) Pub. No.: US 2008/0310778 A1
(43) Pub. Date: Dec. 18, 2008

(54) Air Foil Bearing Having a Porous Foil

(76) Inventors: Yong Bok Lee, Seoul (KR); Chang Ho Kim, Seoul (KR); Jun Hyeon Jo, Daegu (KR); Keun Ryu, Seoul (KR)

Correspondence Address: JONES DAY, 222 EAST 41ST ST, NEW YORK, NY, 10017, US

(21) Appl. No.: 11/665,410

(22) PCT Filed: Nov. 26, 2004
(86) PCT No.: PCT/KR2004/003078

§ 371 Date: Sep. 24, 2007

(30) Foreign Application Priority Data
Oct. 18, 2004 (KR) 10-2004-0083186

(51) Int. Cl. F16C 32/06

(52) U.S. Cl. 384/100

(57) ABSTRACT

There is provided an air foil bearing. The air foil bearing comprises a bearing house and a first foil, wherein a first end of the first foil is fixed with respect to the bearing housing and a second end of the first foil is extended along a peripheral surface of a rotating shaft while maintaining a predetermined clearance with respect to the rotating shaft to thereby become a free end. The air foil bearing also comprises a second foil fabricated from a porous metallic material and extended along the first foil between the first foil and the bearing housing.

### TECHNICAL FIELD

The present invention generally relates to an air foil bearing for supporting a rotating body in an air cycle machine (ACM), which is an essential part of an air conditioning system for aircrafts. More particularly, the present invention relates to an air foil bearing capable of further improving the maximum number of revolution of the supported rotating body by enhancing the vibration-damping capability through using a foil composed of a porous metallic material.

### BACKGROUND ART

A thin film-shaped foil carries an axial load of a rotating shaft rotating at high speeds by using hydrodynamic properties of air, which serves as a lubrication medium. The high-speed rotating body may include an auxiliary power unit (APU) for aircrafts, an air conditioning machine (ACM) for aircrafts and the like. The constitution of such a foil journal bearing is generally similar to that of a general air bearing. However, it differs in that an elastic thin foil, which includes a bump foil, is inserted between the journal and the bearing to thereby provide additional stiffness and damping. The foil is generally a very thin plate having 0.1 to 0.3 mm thickness and is constructed so as to improve wear-resistance. Such improvement is generally achieved by means of coated substance in order to prevent wear, which is caused when the foil contacts the shaft rotating at high speeds.

Generally, wear occurs in the foil journal bearing because the shaft and the bearing contact each other in an unstable manner during start-up and shutdown. Therefore, recent studies have been focused on improving wear-resistance and enhancing load-carrying capability, as well as providing additional damping performance. Such studies seek to develop a bearing capable of providing a supporting force without oil supply under a high temperature condition of 700° C. or more.

The vibration-damping mechanism of the air foil bearing is mainly dependent on an elastic force of the foil, which is installed between a lubricant and an inner surface of a housing.

An example of an air foil bearing, which is constructed in accordance with the prior art, is illustrated in FIG. 1.

As shown in FIG. 1, the air foil bearing has three layers of foil around a rotating shaft 1f. That is, a top foil 1d, a bump foil 1c and a shim foil 1b are arranged in a narrated order from the rotating shaft 1f. Each foil 1d, 1c and 1b is made from stainless steel. One end of each foil 1d, 1e and 1b is fixed to the inner surface of a bearing housing 1h by means of a pin 1h while the other end thereof extends along the inner surface of the housing to thereby form a free end. Surfaces of each foil 1d, 1c and 1b are coated so as to increase friction.

The top foil 1d is positioned with respect to the rotating shaft 1f, wherein an air lubrication film 1g is placed therebetween. The bump foil 1c is disposed so as to enhance the capability of carrying the load of the rotating shaft because of its high stiffness and carries the load of the rotating shaft while being circumferentially deformed when a dynamic pressure is developed by the rotation of the rotating shaft 1f. The shim foil 1b is placed on the inner surface of the housing 1a and causes a frictional action together with the bump foil 1c while protecting the inner surface of the housing.

The above-described foils serve to damp vibrations, which are produced when the rotating shaft 1f rotates inside the air foil bearing. That is, coulomb frictional force produced as each foil is closely contacted to each other and relatively moved therebetween in the circumferential direction by means of self-elasticity, which each foil has, and a dynamic pressure developed during high-speed rotation of the rotating shaft dissipates an energy associated with the vibration of the rotating shaft to thereby damp the vibration.

However, the illustrated prior art air foil bearing is weak in view of energy dissipation mechanism and is thus lacking in the vibration-damping capability. Particularly, in case the vibration exceeds a predetermined critical point, the coulomb frictional force, which is increased by coating each foil, lowers the damping capability.

Such lack or reduction of the damping capability in the air foil bearing may immediately lead to the incapability of supporting the rotating body or breakage of parts due to physical shocks. For example, in case of an external disturbance such as resonance of the system, the bearing, which lacks the damping capability, fails to receive the vibration of the rotating shaft. Thus, it is placed under a state where the rotating shaft can no longer be supported, even though the number of revolution at that time does not reach the maximum number of revolution, wherein the bearing can best support the rotating shaft.

Further, if the damping capability of the air foil bearing is insufficient, the maximum number of revolution of the rotating body, which the bearing can withstand, becomes lowered. Therefore, it is difficult for the illustrated prior art air foil bearing to display its full performance in a turbo system, which needs high-speed rotation.

### DISCLOSURE

### Technical Problem

Therefore, it is an object of the present invention to provide an air foil bearing in which a structure for damping the vibration of the rotating body to be supported is improved and the rotating body is able to be rotated at a higher number of revolution.

### Technical Solution

In order to achieve the above and other objects, the present invention provides an air foil bearing, comprising: a bearing housing; a first foil, wherein a first end of the first foil is fixed with respect to the bearing housing and a second end of the first foil is extended along a peripheral surface of a rotating shaft while maintaining a predetermined clearance with respect to the rotating shaft to thereby become a free end; and a second foil fabricated from a porous metallic material and extended along the first foil between the first foil and the bearing housing.

### DESCRIPTION OF DRAWINGS

FIG. 1 is a sectional view illustrating an air foil bearing of the prior art.

FIG. 2 is a sectional view illustrating an air foil bearing having a porous foil in accordance with the present invention.

FIG. 3 is a schematic sectional view illustrating the damping actions of foils before deformation, which are used in the present invention.

FIG. 4 is a schematic sectional view illustrating the damping actions of foils after deformation, which are used in the present invention.

FIG. 5 is a graph illustrating a vibration-damping effect in a superbending operation experiment, which is implemented as the bearing having a porous foil formed using a metallic chip in accordance with the present invention and the prior art bump foil bearing are applied in a turbo system.

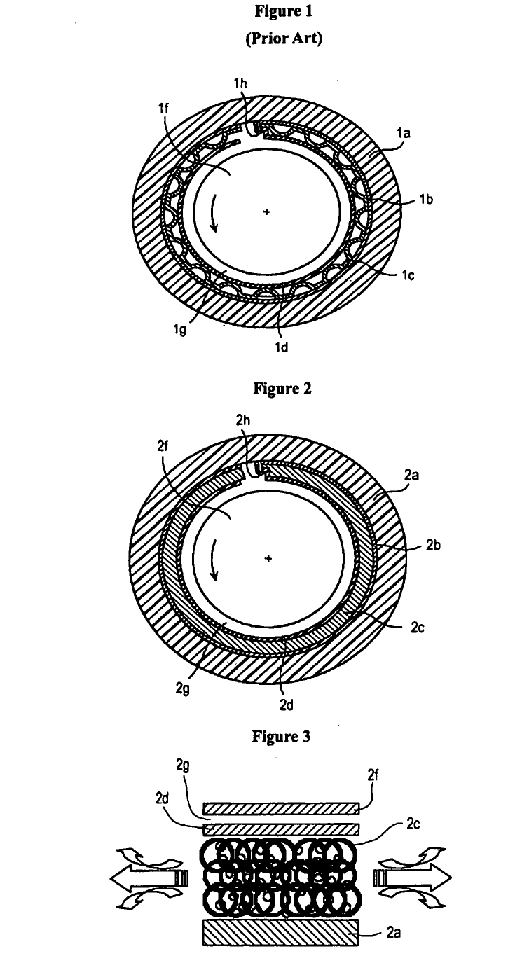

### BEST MODE

The preferred embodiments of the present invention will now be described in detail with reference to the accompanying drawings.

FIG. 2 illustrates a sectional view of an air foil bearing constructed in accordance with the present invention.

Referring to FIG. 2, the air foil bearing, which is constructed in accordance with the present invention, comprises a bearing housing 2a, a top foil 2d, a porous foil 2c and a shim foil 2b.

The top foil 2d is arranged in the innermost inside of the bearing housing 2a and is positioned with respect to a rotating shaft 2f while placing an air lubrication film 2g therebetween. An upper surface of the top foil 2d, which is a surface thereof facing the rotating shaft 2f, is formed with a coating surface for solid lubrication so that friction with the rotating shaft 2f is minimized during start-up and shutdown of the rotating shaft 2f. Those skilled in the art are well aware of such coating treatment for purposes of increasing frictional forces between foils in an air foil bearing. Thus, the detailed description thereof is omitted herein.

One end of the top foil 2d is fixed to an inner surface of the bearing housing 2a by means of a pin 2h while the other end of the top foil 2d becomes a free end.

The porous foil 2c, which is an essential member of the present invention, is fabricated from a metallic material and is arranged at a lower side of the top foil 2d. The porous foil 2c is constructed so as to be capable of utilizing the stiffness property and structural damping property of a material as well as a squeeze principle wherein a geometric resistance property of a pore reduces the leakage of hot air and an additional damping effect with respect to air is thereby produced inside the foil, hence enhancing energy dissipation.

In the preferred embodiment of the present invention, the porous foil 2c is formed by working metallic chips. The material of the chip may include any material, which is capable of elastically deforming and absorbing shocks when the dynamic or static force is exerted. Preferably, the material of the chip is a material of spring steel of Inconel series wherein the restoring force depending on elasticity is superior, or a material of cast iron series wherein the shock-absorbing property is excellent. According to an experiment, such properties of the material were found to have important influence on the air damping effect not only at room temperature but also at high temperature.

In the preferred embodiment of the present invention, the chip foil may be formed by being squeeze molded under heat and pressure of certain level or more through using a hot plate. That is, the chip foil may be formed via two molds of a male and female type, which are sized so as to match the size of the bearing. The material for the chip foil (for example, Inconel 718) may be inserted into the molds, wherein the high temperature and high pressure states are maintained for a long time by using a hot plate equipment.

As mentioned above, the coating treatment may be performed on a lower surface of the porous foil 2c, that is, the surface facing the shim foil 2b, in order to increase frictional force.

The shim foil 2b is arranged between the inner surface of the bearing housing 2a and the lower surface of the porous foil 2c. The coating treatment is performed on an upper surface of the shim foil 2b, that is, a surface facing the porous foil 2c, so as to increase frictional force in relative movement to the porous foil 2c.

Preferably, the above-described top foil 2d, porous foil 2c and shim foil 2b are fabricated from Beryllium-copper, stainless steel or steel of Inconel series. One end of each of the above-described foils is fixed to the inner surface of the bearing housing 2a by means of a pin 2h while the other end of each of the above-described foils becomes a free end.

While the air foil bearing, which is constructed in accordance with the preferred embodiment of the present invention, is shown to have three layers of foil, it should be noted herein that the present invention is not limited thereto. For example, a bump foil may be interposed between the shim foil 2b and the porous foil 2c. Further, a bump foil may be used instead of the shim foil 2b. In case there is no apprehension about breakage of the inner surface of the bearing housing 2a and the vibration-damping capability is sufficient, the shim foil 2b may be omitted. It was found that using the bump foil and the porous foil 2c together improves the vibration-damping effect.

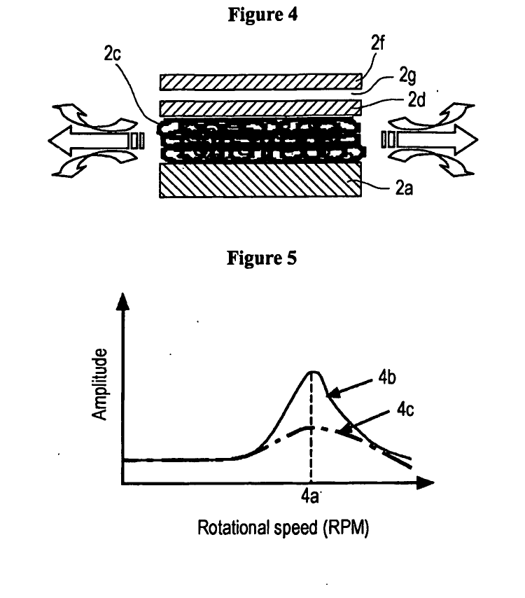

The operation of the air foil bearing, which is configured as above, will now be described with reference to FIGS. 3 and 4 by way of example wherein the shim foil 2b does not exist.

If the rotating shaft 2f, which is located over a smooth upper surface of the top foil 2d, initiates rotation from a stationary state, then the rotating shaft 2f floats up and the dynamic pressure acts in the radially outward direction of the rotating shaft 2f inside the air lubrication film 2g. At this time, as shown in FIG. 3, in case the vibration of the rotating shaft is small and the dynamic pressure is constant, the amount of deformation of each foil including the porous foil 2c is small and the frictional forces between surfaces of each foil also do not significantly act.

However, as shown in FIG. 4, in case a large pressure caused by the vibration of the rotating shaft 2f acts on the surfaces of foils, all foils 2c and 2d are elastically deformed. That is, the top foil 2d and the porous foil 2c shrink in thickness and are lowered in height while being deformed in the circumferential and axial directions. Further, under the action of the pressure caused by the vibration, the frictional forces are produced on the contact surfaces between respective foils. In such a case, between the lower surface of the top foil 2d and the upper surface of the porous foil 2 and between the upper surface of the shim foil 2b and the lower surface of the porous foil 2d, the structural damping property of the material as well as the additional damping effect with respect to air, which results from the leakage reduction of hot air by the resistance of the pores of the chip foil, appear whereby energy dissipation takes place significantly.

Such energy dissipation due to the elastic deformation and the frictional force converts pressure changes, which are caused by the vibration, into other types of energy within a shorter time, thus enhancing the damping effect for the vibration.

FIG. 5 is a graph illustrating a vibration-damping effect in a superbending operation experiment, which is implemented as the bearing having the porous foil and a prior art bump foil bearing are applied in a turbo system. The rotational speed 4a indicates the rotational speed at which resonance takes place, for example, 30,000 RPM. As seen in FIG. 5, a curve 4b indicating the amplitude of the general air foil bearing and a curve 4c indicating the amplitude of the bearing using the porous foil in accordance with the present invention show a large difference between the amplitudes in the vicinity of the resonant rotational speed.

Meanwhile, an experiment shows that the relative density has an important influence on the air damping effect at room temperature and at high temperature.

The relative density expresses mass of chips under the condition of constant volume as a percentage. The relative density is often substituted with porosity.

Relative density=1−[(mass of Inconel−mass of chip)/unit volume]

Porosity=1−Relative density

Generally, the values of physical properties vary according to the porosity. As the porosity is higher, the relative density of the chip foil becomes lower and mass per unit volume becomes lighter.

The experiment was performed in a state where an Inconel 718, which is generally utilized for spring steel and has a density of about 8510 kg/m³, was machined so as to form a plurality of minute chips, wherein a chip is 1 μm in size. The chips were then squeeze molded to form a foil having the same size as that of a top foil and the foil was then disposed on the rear surface of the top foil.

The Inconel 718, which was used in the experiment, had the following values of physical properties:

Maximum use temperature: 150° C., Elastic Modulus: 3×10⁴˜2×10⁷, Loss Factor: 0.2˜0.9.

The chip foil has a 0.45 mm thickness. The value of stiffness coefficient and the value of damping coefficient, which are measured by means of an exciter, have the range of 2.0˜4.2×10⁵ and 2.0˜2.7×10³, respectively.

Dimensions of two air foil bearings are as follows:

Diameter of a rotating shaft: 35 mm

Thickness of a top foil: 0.1 mm

Thickness of a porous foil: 0.45 mm

Height of a bump foil: 0.45 mm

Thickness of a shim foil: 0.076 mm

Thickness of an air lubrication film: 0.07 mm

### INDUSTRIAL APPLICABILITY

The air foil bearing constructed in accordance with the present invention comprises a porous foil whereby it can significantly improve the cycle and amplitude of the vibration of a system having a high-speed rotating body. This is due to the damping property of the porous foil. Further, when compared to the prior art air foil bearing, the air foil bearing constructed in accordance with the present invention is advantageous in that a system employing it can take a more stable shape in behavior of vibration.

The prior art foil bearing, which has only the structural damping function, has a limited damping force and the design thereof is fairly dependent upon experts. However, the porous foil of the present invention is advantageous in that applicability is superior. This is because an excellent vibration-damping performance and an excellent vibration-damping capability are obtained due to the additional damping effect of air. Thus, an easier design is possible.

The air foil bearing constructed in accordance with the present invention can be utilized for not only a bearing in a gas turbine or steam turbine, which needs a bearing to be placed under high-temperature conditions such as a turbine part, but also can be used for a bearing in rotating machinery for a very low temperature refrigerant. Further, it can be applied to systems having a high-speed operation range, which is more than critical speed, such as a turbo charger employed in a diesel vehicle, etc. In such a case, it can further improve a turbo lag in the turbo charger because it has lesser friction compared to existing oil bearings.

The present invention provides an air foil bearing with a superior vibration-damping capability and without oil supply.

1. An air foil bearing, comprising:
a bearing housing;
a first foil having first and second ends, the first end of the first foil being fixed with respect to the bearing housing, the second end of the first foil being extended along a peripheral surface of a rotating shaft while maintaining a predetermined clearance with respect to the rotating shaft to thereby form a free end; and
a second foil fabricated from a porous metallic material, the second foil being extended along the first foil between the bearing housing and the first foil.

2. The air foil bearing of claim 1, wherein the air foil bearing further comprises a third foil having first and second ends, the third foil being positioned between the second foil and the bearing housing, the first end of the third foil being fixed with respect to the bearing housing, the second end of the third foil forming a free end.

3. The air foil bearing of claim 1, wherein the air foil bearing further comprises a bump foil having first and second ends, the bump foil being positioned between the second foil and the bearing housing, the first end of the bump foil being fixed with respect to the bearing housing, the second end of the bump foil forming a free end.

4. The air foil bearing of claim 2, wherein the air foil bearing further comprises a bump foil having first and second ends, the bump foil being positioned between the second foil and the third foil, the first end of the bump foil being fixed with respect to the bearing housing, the second end of the bump foil forming a free end.

5. The air foil bearing of any one of claims 1 to 4, wherein the second foil is formed by squeeze molding metallic chips so as to be porous.

6. The air foil bearing of claim 5, wherein the metal is selected from the group consisting of a spring steel and a cast iron.
